(19) United States
(12) Patent Application Publication
(10) Pub. No.: US 2014/0318194 A1
(43) Pub. Date: Oct. 30, 2014

(54) DRAWER LOCKING SYSTEM

(71) Applicant: Edward B. Harriss, Newbury, MA (US)

(72) Inventor: Edward B. Harriss, Newbury, MA (US)

(21) Appl. No.: 13/873,561

(22) Filed: Apr. 30, 2013

(51) Int. Cl. E05B 65/46

(52) U.S. Cl. CPC E05B 65/46
USPC 70/78

(57) ABSTRACT

A locking system is provided which can be readily attached to a drawer without the necessity of any carpentry or other alteration of the drawer or associated cabinet. The locking system comprises a first body having at least one side attachable to the front of a drawer, a second body which has a side attachable to a surface of the drawer cabinet adjacent to the movable drawer. A cable or cord is permanently attached to one body and is removably attached to the other body and retained in place by a lock mechanism in this other body. The lock mechanism may be key actuated or may actuated by a combination lock.

### STATEMENT REGARDING FEDERALLY SPONSORED RESEARCH OR DEVELOPMENT

### BACKGROUND OF THE INVENTION

A variety of locking devices and systems are known for locking drawers such as desk drawers and file cabinets and for locking cupboard and other doors. Such locks require that the drawer or door have openings provided to accommodate the lock device. For example, in a typical drawer lock, openings must be milled out of the drawer front of a size and configuration to accommodate the lock housing and a front facing opening must be provided to accommodate a key. In addition, an opening in the confronting frame of the drawer must be milled to provide a striker plate and opening to accommodate the lock bolt when in a locked position.

It would be useful and convenient to have a locking system which can be installed on a drawer or door without the necessity of milling or otherwise providing openings in the drawer or associated cabinet.

### BRIEF SUMMARY OF THE INVENTION

The present invention provides a locking system which can be readily attached to a drawer without the necessity of any carpentry or other alteration of the drawer or associated cabinet. The locking system comprises a first body having at least one side attachable to the front of a drawer, a second body which has a side attachable to a surface of the drawer cabinet adjacent to the movable drawer. A cable or cord is permanently attached to one body and is removably attached to the other body and retained in place by a lock mechanism in this other body. Typically, the cable is permanently attached to the body which is secured to a cabinet wall, and the detachable end of the cable is lockable in the lock mechanism of the body which is secured to the drawer front. The lock mechanism is actuatable by a user to lock and unlock the mechanism. In the locked position, one end of the cable is secured within the mechanism. In the unlocked position, the end of the cable is releasable from the locking mechanism so that the drawer can be opened. The cable end lockable within the lock mechanism has an end element mateable with one or more cooperative elements of the locking mechanism to retain the cable in the locked position.

The lock mechanism may be key actuated or may be actuated by a combination lock. The lock mechanism itself can be of any known construction. While the invention is described in a preferred embodiment for use with a desk drawer or other cabinet drawer that is slidably openable and closable, it is contemplated that the invention is also applicable to cupboard and other doors or panels which can be swingably or slidably opened and closed, or box or other enclosure lids or drawers which are moveable in relation to a fixed wall or panel.

The lock system bodies can be attached respectively to the drawer and to an adjacent cabinet wall by an adhesive sufficiently strong to prevent easy removal of the bodies. Alternatively, the lock system bodies can be fastened to the mounting surfaces of the drawer and cabinet wall by one or more fasteners. The use of fasteners will necessitate the drilling of holes through the walls of the cabinet and drawer to accommodate screws or other fastening elements to achieve a more permanent lock system installation.

### BRIEF DESCRIPTION OF THE SEVERAL VIEWS OF THE DRAWINGS

The invention will be more fully understood from the following detailed description taken in conjunction with the accompanying drawings in which:

FIG. 1 is a diagrammatic elevation view of the invention installed on a desk and drawer;

FIG. 2 is a pictorial view of an embodiment of the invention using an adhesive layer;

FIG. 3 is a cutaway view illustrating another embodiment of the invention using one or more fasteners;

FIG. 4A is a plan view of an embodiment of the invention showing a cable end inserted in a lock body before locking;

FIG. 4B is a plan view of the embodiment of FIG. 4A after locking;

FIG. 5A shows an embodiment of the invention using a retractable cable mechanism, shown in retracted position;

FIG. 5B shows the embodiment of FIG. 5A with the cable in an extended position;

FIG. 5C shows the embodiment of FIGS. 5A and 5B with the cable in locked position;

FIG. 5D is a cutaway plan view showing the cable engaging slot of the embodiment of FIGS. 5A, 5B and 5C;

FIG. 6 is a pictorial view of a cable end element of cylindrical form;

FIG. 7 is a pictorial view of a receptacle for receiving the cable end element of FIG. 6;

FIG. 8 is a pictorial view showing a further embodiment using first and second cables;

FIG. 9 is a pictorial view of yet another embodiment using a single cable locked into a single body;

FIG. 10 is a pictorial view of an embodiment having a wraparound cable; and

FIG. 11 is an embodiment similar to that of FIG. 10 and having a wraparound cable cooperative with a drawer pull on a drawer.

### DETAILED DESCRIPTION OF THE INVENTION

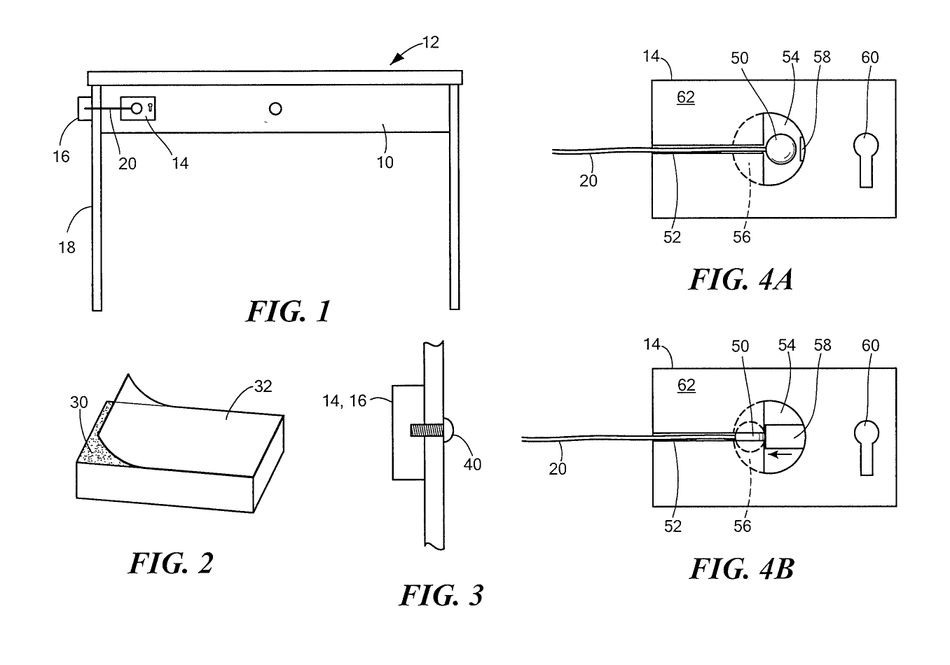

A lock system in accordance with the invention is shown in a typical installation in FIG. 1. In the illustrated embodiment, the lock system or locking system is shown attached to the slidable draw 10 of a desk 12. The lock system includes a first body 14 attached to the front of draw 10, and a second body 16 attached to the side 18 of the desk 12. A cable or cord 20 is permanently attached to body 16 and releasably attached to body 14 when in the locked position. The body 14 includes a lock mechanism which is actuatable by a user such as by a key or combination lock to lock and unlock the mechanism. In the locked position, the end of the cable captured in body 14 is secured by the lock mechanism. In the unlocked position, the end of the cable retained by the lock mechanism in body 14 is released so that the cable can be removed from the body 14 allowing the draw 10 to be opened and closed by a user.

The bodies 14 and 16 can be affixed to the respective surfaces of the draw front and desk side by an adhesive material which is sufficiently strong to prevent ready removable of either any of the bodies from the mounting surfaces. In one embodiment, the adhesive can be pre-applied to the mounting surface of each body 14, 16 shown in FIG. 2 as layer 30, and a release layer 32 can be applied over the adhesive layer to cover the adhesive layer until installation of the lock bodies onto their mounting surfaces. For mounting of the bodies containing an adhesive layer, the release layer 32 is peeled away and the exposed adhesive layer pressed against the respective mounting surfaces to adhere the respective bodies to their mounting surfaces. In another embodiment, an adhesive can be applied to the mounting surface of bodies 14 and 16 from a tube or can of adhesive material just prior to pressing the bodies 14 and 16 onto the mounting surfaces.

In an alternative embodiment, one or both of the bodies 14 and 16 can be attached to their respective mounting surfaces by one or more fasteners. For example, as shown in FIG. 3, a fastener 40 such as a machine screw is inserted through an opening provided in the mounting wall of the desk side and/or draw front and threaded into a threaded opening in the lock body 14 and/or 16. The use of a fastener such as shown in FIG. 3, will necessitate the drilling of one or more holes through the walls of the mounting structure to accommodate the screw or other fastening element. For many purposes, the adhesive mounting is preferred as no holes need be drilled in the draw or cabinetry of the mounting structure with which the locking system is employed.

The cable 20 can be for example a stainless steel flexible cable which may be covered with a plastic, rubber or other relatively soft or pliant material which will not scratch or otherwise mar the confronting surfaces of a desk or other piece of furniture or cabinetry with which the locking system is employed.

The cable or cord can also be a flexible non-metallic material such as Kevlar. The cable end affixed to body 16 can be secured in the body by any convenient means. For example, the cable end can extend through an opening in a side of body 16 and be retained therein by a clamp or other mechanism in the body which is constructed in a sufficiently robust manner to prevent easy pulling of the cable end from the body. The cable may also be welded or otherwise secured within body 16, such as by an epoxy adhesive.

Alternatively, the cable can be a chain of metal or plastic material. In another implementation, a 90° angled bar or rod can be employed instead of a cable, cord or chain. In this version, one end of the bar can be attached to one lock body and the other end of the bar can be releasably attached to the other lock body. The bar can, alternatively, be releasably attached at both ends to respective lock bodies. For purposes of this invention, the term “cable” is intended to mean a flexible cable of cord of any suitable material or a rigid bar or rod of any suitable material.

The end of the cable 20 lockable within the lock mechanism of body 14 can have an end or retention element mateable with one or more cooperative elements of the locking mechanism for the purposes of retaining the cable in the body when in the locked position. In one embodiment shown in FIGS. 4A and 4B, the cable 14 has a ball 50 welded or otherwise secured to an end of the cable. The body has a slot 52 provided on the front which can accommodate the cable along its length. The ball 50 fits into a well or recess 54 and is urged and retained in a receptacle area 56 by a bolt 58 of a locking mechanism in the body. The bolt is actuated by a key inserted into keyhole 60. With the bolt 58 retracted, as shown in FIG. 4A, the ball 56 can be fitted into the recess 54 of the body. When the bolt 58 is extended into its locked position by operation of the key actuated lock in the body, as seen in FIG. 4B, the ball 56 is urged under a cover plate 62 or front of the body 14 into a receptacle area of the recess 54 sized to receive the ball 56. In this locked position, the cable is retained in the body.

The bodies 14 and 16 are positioned such that the cable 20 is almost taut or slightly slackened so that the drawer 10 cannot be moved outward by a distance sufficient to gain access to the interior of the drawer. It is usually preferable to mount body 14 at the side edge of the drawer to minimize the amount of drawer travel before the cable tightens to prevent further movement. The lock mechanism itself can be of any known construction and can be key actuated or actuated by a combination lock. In some embodiments, a lock bolt may be employed which is spring loaded in a normally outward position. In an unlocked state, the bolt can be pushed inward by a ball or other retention element on the cable and then the bolt can be released to urge the ball or other retention element into the receiving receptacle prior to locking the lock and capturing the ball or other retention element in body 14.

In another embodiment, the end of the cable securable in the body 14 need not have a retention or end element, and the cable end can itself be secured in body 14. For example, the free end of cable 20 can be threaded into an opening in the side of body 14, and in a locked position, the portion of the cable within the body can be captured by clamping elements to prevent cable removal when the locking mechanism is in its locked position.

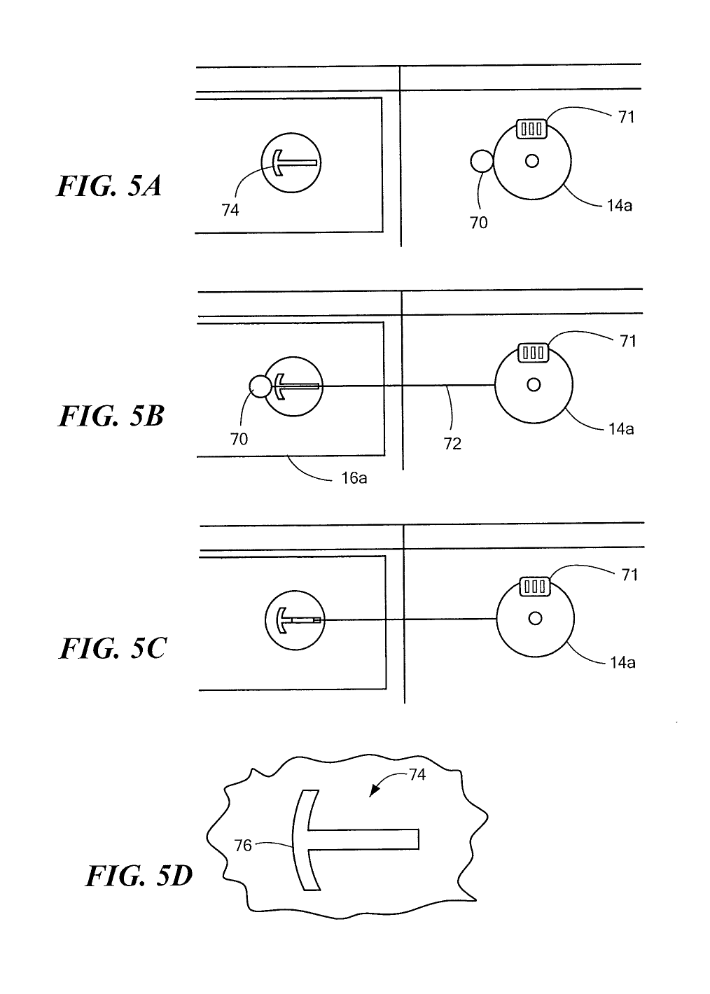

An embodiment is shown in FIGS. 5A, 5B and 5C in which the body attachable to the draw front includes a retractable cable mechanism. In FIG. 5A, the cable is in a retracted position with end element 70 abutting the housing of the body 14a. In FIG. 5B, the cable 72 is shown in an extended position with the end element 70 in position to be inserted into the receptacle 74 of body 16a which is attached to the side of the desk or cabinet adjacent to the slidable draw. In FIG. 5C, the end element 70 is shown disposed within receptacle 74 and pulled inward into the receptacle by slight retraction of cable 17 into body 14a. The body 14a includes a lock mechanism 71 such as a combination or key lock which in locked position secures the cable against outward movement which could cause the retaining element to come loose from the receptacle of body 16a. The receptacle 74 includes a T-shaped slot illustrated in enlarged form in FIG. 5D. The end element cooperative with this T-slot is in the form of a disc attached to one end of cable 72 and sized to fit within slot portion 76 and into a recess or chamber below the slot when the cable 72 is moved toward the body 14a.

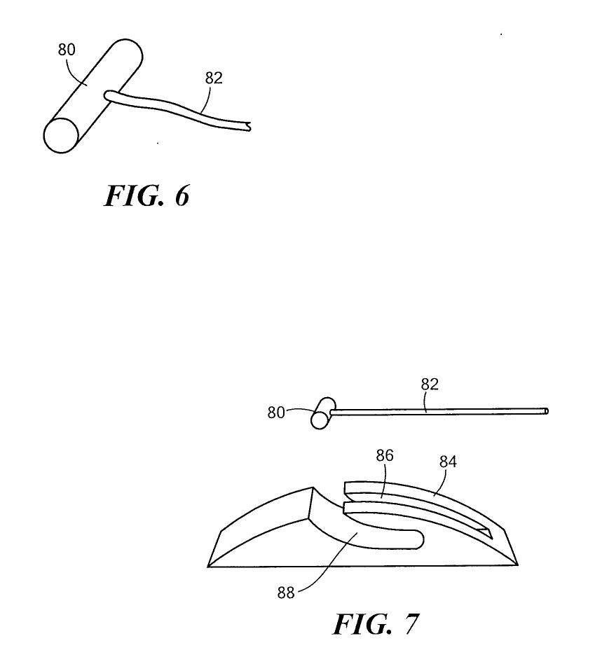

FIG. 6 shows an end element 80 attached to cable 82 and which is in the shape of a cylinder. The cylinder is cooperative and can be retained in the receptacle shown in FIG. 7 which includes a pair of fingers 84 spaced with a slot 86 sized to receive cable 82 when in a locked position. The cylinder 80 is retained in the slotted area 88 below the fingers 84 in the locked position.

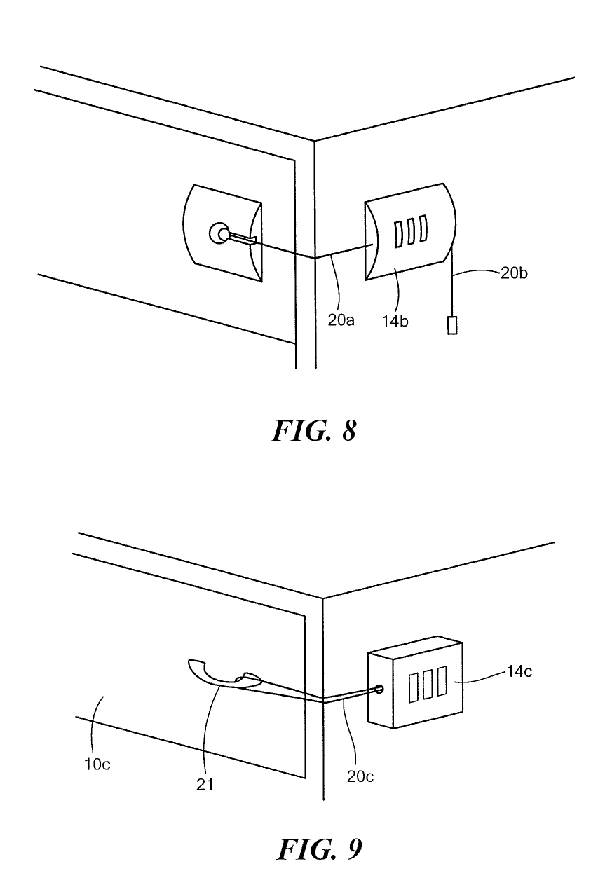

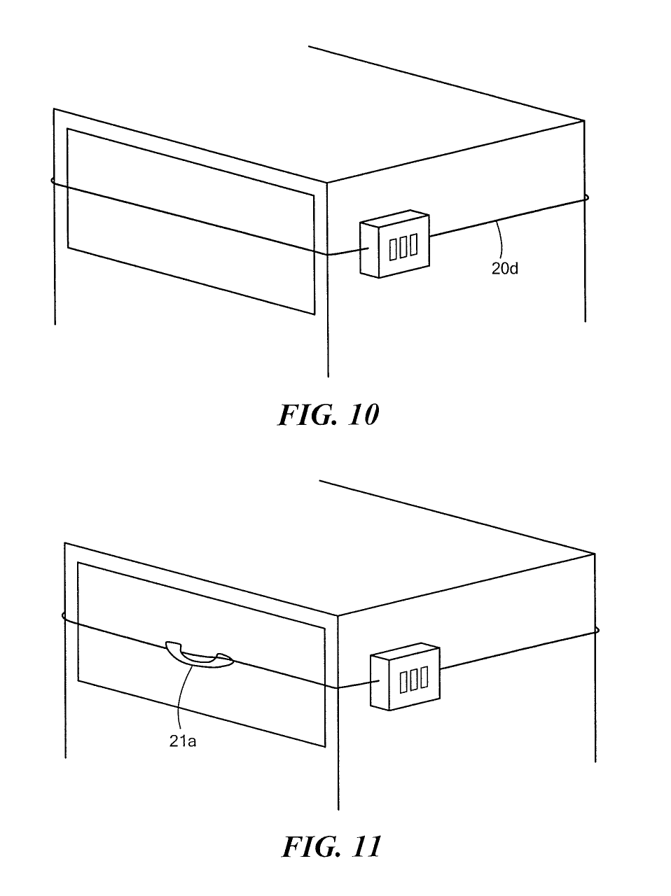

Another embodiment is shown in FIG. 8 in which body 14b has two cables 20a and 20b each having an end securable to body 14b and each having an outer retention element cooperative with the receptacles of respective second bodies 16a, only one being shown. FIG. 9 shows yet another embodiment in which the body 14c has a cable 20c which can be looped around a receptacle 21 such as a draw pull on slidable draw 10c and locked into the body. In further embodiments, a cable 20d can be of sufficient length to wrap around an entire cabinet and across a draw front as shown in FIG. 10. In this wraparound version, the cable can pass through a draw pull 21a or other such element on the draw front before being locked into the lock body as shown in FIG. 11.

The invention can alternatively be implemented with each of the two lock bodies having a locking mechanism for releasably securing respective ends of the cable when in an unlocked position.

The invention is not to be limited by what has been particularly shown and described but is to embrace the full scope and spirit of the appended claims.

1-8. (canceled)

9. A lock system for a panel movable in relation to a fixed wall, the lock system comprising:
a first body having a locking mechanism and a receptacle, at least one side attachable to a mounting surface of at least one of a front of the panel and the fixed wall;
a second body having at least one side attachable to a mounting surface of at least one of the front of the panel and the fixed wall in a position adjacent to the one of front of the panel and the fixed wall including the first body;
a cable having a first end permanently attached to the second body and having a second end removably attachable to the receptacle of the first body;
the locking mechanism actuatable by a user to lock the locking mechanism with the second end of the cable secured in the receptacle of the first body and to unlock the locking mechanism to allow release of the second end of the cable from the receptacle of the first body
wherein the second end of the cable is threaded into the receptacle of the first body and wherein the locking mechanism includes at least one clamping element to prevent removal of the second end of the cable when the second end of the cable is within the first body and the locking mechanism is in the locked position.

10-11. (canceled)

12. The lock system of claim 9 wherein the front of the panel is a drawer front.

13. The lock system of claim 9 wherein at least one of the first body and the second body include an adhesive on a mounting surface thereof for attachment of the respective body to the respective panel and fixed wall.

14. A lock system for a panel movable in relation to a fixed wall, the lock system comprising:
a first body having a locking mechanism and a first body receptacle, at least one side of the first body attachable to a mounting surface of at least one of a front of the panel and the fixed wall;
a second body having a second body receptacle and at least one side attachable to a mounting surface of at least one of the front of the panel and the fixed wall in a position adjacent to the one of the front of panel and the fixed wall including the first body;
a cable having a first end permanently attached to the first body having the locking mechanism and having a second end removably attachable to the second body receptacle; and
the locking mechanism actuatable by a user to lock the locking mechanism with the second end of the cable secured in the second body receptacle and to unlock the locking mechanism to allow release of the second end of the cable from the second body receptacle.

15. The lock system of claim 14,
wherein the cable is adapted for alternating between a retracted position and an extended position;
wherein in the retracted position, the cable is retracted within a housing of the first body having the locking mechanism with the second end of the cable abutting an exterior of the housing; and
wherein in the extended position, the cable is extended from the first body having the locking mechanism with the second end of the cable in a position to be disposed within the second body receptacle.

16. The lock system of claim 15 wherein the second end of the cable is adapted to be pulled inward into the second body receptacle by a slight retraction of the cable into the first body having the locking mechanism.

17. The lock system of claim 14 wherein the front of the panel is a drawer front.

18. The lock system of claim 14 wherein at least one of the first body and the second body include an adhesive on a mounting surface thereof for attachment of the respective body to the respective panel and fixed wall.

19. A lock system for a panel movable in relation to a fixed wall, the lock system comprising:
a first body having a locking mechanism and a first body receptacle, at least one side of the first body attachable to a mounting surface of the fixed wall;
a cable permanently attached to the first body having the locking mechanism and having a first end and a second end configured to be retained within the first body receptacle when the locking mechanism is in locked position, the cable being of sufficient length to loop at least one of the first end and the second end through a panel receptacle situated on a front of the panel prior to the respective first or second end being locked into the locking mechanism; and
the locking mechanism actuable by a user to lock the locking mechanism with the first end and the second end of the cable secured in the first body receptacle and to unlock the locking mechanism to allow release of at least one of the first end and the second end of the cable from the first body receptacle;
wherein the front of the panel is a drawer front.

20. The lock system of claim 19 wherein the first body includes an adhesive on a mounting surface thereof for attachment of the first body to the fixed wall.
